(19) United States
(12) Patent Application Publication
(10) Pub. No.: US 2025/0327627 A1
(43) Pub. Date: Oct. 23, 2025

(54) COOLING DEVICE ARRANGEMENT

(71) Applicant: AUDI AG, Ingolstadt (DE)

(72) Inventors: Markus THURMEIER, Adlkofen (DE); Florian DIRISAMER, Grieskirchen (AT)

(73) Assignee: AUDI AG, Ingolstadt (DE)

(21) Appl. No.: 19/082,519

(22) Filed: Mar. 18, 2025

(30) Foreign Application Priority Data
Apr. 22, 2024 (DE) 102024111140.2

(51) Int. Cl. F28D 20/02; B62D 25/02; F28D 21/00

(52) U.S. Cl. CPC F28D 20/021; B62D 25/025; F28D 2021/008

(57) ABSTRACT

A cooling device arrangement including a vehicle body element with a hollow profile that provides a receiving space; and a cooling device including an inner profile component on the outer surface of which a transport channel is provided through which a heat carrier fluid can flow. Dimensions of the cooling device are adapted to the hollow profile such that the cooling device can be inserted into the receiving space of the hollow profile and is held in the receiving space in a form-fitting manner and without gluing.

### FIELD

The invention relates to a cooling device arrangement, in particular in the field of motor vehicles.

### BACKGROUND

Currently, excess heat in motor vehicles is cooled down by increased cooling requirements by means of fans or air conditioning compressors, which requires a relatively large amount of energy. In addition, vehicle cooling systems are usually at full capacity and can no longer be cooled down at high cooling capacities, which reach over 200 kW, in particular during super-fast charging, which reduces charging capacity. Furthermore, current cooling devices require a lot of space and are permanently installed in the motor vehicle, in particular glued, which makes replacing defective cooling devices difficult.

From CN 116 262 434 A, a vehicle side beam, an electric drive system, a drive train assembly and a corresponding vehicle are known. The vehicle side beam comprises a profile body, the profile body further comprises a shell and a guide tube, wherein the guide tube is arranged in the shell, and wherein the guide tube is connected to the cooling system with a cooling liquid pump and an electric drive and transfers cooling liquid between the cooling liquid pump and the electric drive.

From DE 10 2017 103 268 A1, an electrical conductor arrangement comprising at least one conductor profile is known. The conductor profile is bar-pressed and consists of a light metal alloy, wherein the conductor profile has at least one circumferentially closed channel. Preferably, the conductor profile consists of a aluminum wrought alloy. The channel is designed in particular for the passage of a heat carrier medium. Several conductor profiles are coupled together to form a conductor strand, which is employed in a motor vehicle. An electrical conductor arrangement can form the electrical path between a charging socket and the electrical energy accumulator.

From DE 10 2015 011 866 A1, a heat transfer arrangement for a motor vehicle is known, with at least one heat tube, which is connected on the one hand to a heat source via a heat exchanger and on the other hand to a heat sink. It is intended that a latent heat accumulator is assigned to the heat exchanger.

### SUMMARY

The object of the invention is to provide a cooling device in a cooling device arrangement which in particular requires less space and can be mounted or replaced in an improved manner.

One aspect of the invention relates to a cooling device arrangement comprising a vehicle body element with a hollow profile that provides a receiving space and a cooling device comprising an inner profile component on the outer surface of which a transport channel is provided through which a heat carrier fluid can flow. The dimensions of the cooling device are adapted to the hollow profile such that the cooling device can be inserted into the receiving space of the hollow profile and is held in the receiving space in a form-fitting manner and without gluing.

In other words, a cooling device, in particular a passive cooling device, is provided, the dimensions of which are adapted to a receiving space of a hollow profile of a vehicle body element such that the latter can be inserted into the receiving space and is held at least laterally by walls of the hollow profile. This means that no further fastening, in particular gluing, of the cooling device is necessary, whereby the cooling device is recyclable and removable. In addition, existing space in the vehicle body element can be used optimally.

For cooling or removing heat from a vehicle system, the cooling device can have an inner profile component and a transport channel for guiding a heat carrier fluid. The inner profile component can have a thermally conductive and/or heat-storing material which can in particular receive and temporarily store heat from the heat carrier fluid. For example, the inner profile component can be formed from a metal or thermally conductive plastic or at least comprise an outer wall made of these materials. Preferably, the inner profile component can have further heat accumulators, such as a phase change accumulator or latent heat accumulator. This design of the cooling device makes it possible to receive and compensate for temperature peaks, wherein the heat can be released again after the temperature peak. The shape of the inner profile component and thus of the cooling device is in particular adapted to the shape of the hollow profile, which can be, for example, square or tubular.

The heat carrier fluid, which is guided through the transport channel and was heated, for example, by a vehicle component, in particular a vehicle battery or computing unit, can be in a liquid, gaseous or mixed state in between. For example, water, a water-glycol mixture or an oil can be used as a heat carrier fluid.

The vehicle body element with the hollow profile can be a vehicle sill or a battery profile, for example. In particular, heat from a vehicle battery can be received by the heat carrier fluid of the cooling device and temporarily stored.

The invention offers the advantage that a recyclable cooling device can be provided which can in particular be installed or removed quickly.

The invention offers the advantage that heat peaks can be better received and temporarily stored. Furthermore, an installation space requirement is reduced and optimally adapted to existing receiving spaces. Since no further fastenings, in particular gluing, are required for the cooling device, it can also be easily removed or replaced.

The invention also comprises design forms which result in additional advantages.

One design form provides that the cooling device further has a guide structure which is arranged on the outer surface of the inner profile component, wherein dimensions of the guide structure are adapted to the hollow profile such that the inner profile component with the guide structure can be inserted into the receiving space of the hollow profile and is held in the receiving space in a form-fitting manner and without gluing, wherein when the inner profile component with guide structure is inserted, an intermediate space is formed between the hollow profile and the inner profile component, which forms the transport channel for the heat carrier fluid. This means that a guide structure can be arranged around an outer surface of the inner profile component, which corresponds to the dimensions of the hollow profile. The inner profile component can, for example, be inserted into the guide structure, wherein the inner profile component with guide structure can then be inserted into the receiving space of the hollow profile. The guide structure can be provided in the form of fluid guide ribs which define the transport channel, wherein the transport channel is formed by an intermediate space which is defined on one side by the outer surface of the inner profile component and on the other side by the surface of the hollow profile. The guide structure can be provided as a metal or plastic structure, for example manufactured by 3D printing, into which the inner profile component can be inserted. It is preferably provided that the guide structure and the inner profile component represent seamlessly joined components. This design form offers the advantage that material can be saved and that the dimensions of the guide structure facilitate adaptation to the hollow profile.

A further design form provides that the cooling device further has an outer profile component into which the inner profile component can be inserted such that the outer profile component surrounds the outer surface of the inner profile component and the transport channel is formed in an intermediate space between the outer profile component and the inner profile component, wherein the outer profile component has a phase change accumulator, and wherein the outer profile component is adapted to the hollow profile such that it can be inserted into the receiving space of the hollow profile and is held in the receiving space in a form-fitting manner and without gluing. In other words, it can be provided that the cooling device has an outer profile component into which the inner profile component can be inserted, so that an intermediate space is created between the inner profile component and the outer profile component, which forms the transport channel for the heat carrier fluid. A phase change accumulator can be provided in the outer profile component, for example in a wall of the outer profile component, which can additionally receive and temporarily store heat. The phase change accumulator can, for example, already be present in the outer profile component or can be filled in later. A phase change accumulator or latent heat accumulator can receive thermal energy in the form of conversion enthalpy by causing a phase change, in particular between solid and liquid. In this variant, the outer profile component can be adapted to the dimensions of the hollow profile so that the outer profile component, into which the inner profile part is inserted, can be seamlessly inserted into the receiving space of the hollow profile. Walls of the outer profile component are preferably formed from a thermally conductive material, for example a metal. In a simplified variant, the outer profile component can be viewed as an outer tube into which the inner profile component is inserted.

A further advantageous design form provides that a guide structure for guiding the heat carrier fluid is arranged in the intermediate space between the outer profile component and the inner profile component, through which the transport channel is formed. This means that, for example, fluid guide ribs can be arranged in the intermediate space so that the heat carrier fluid can be guided around the inner profile component. This results in the advantage that better heat distribution can be achieved.

A further design form provides that the inner profile component has a phase change accumulator which is formed and arranged to receive heat of the heat carrier fluid by changing a phase state. In other words, a phase change accumulator can be arranged in the inner profile component in order to temporarily store the heat, which can better receive heat peaks. In particular, the phase change accumulator of the inner profile component can be combined with the phase change accumulator of the outer profile component.

In a further advantageous design form, it is provided that an inner core of the inner profile component is formed as a phase change accumulator. This means that the phase change accumulator can be integrated into the inner profile component. Alternatively or additionally, the phase change accumulator can be arranged in an outer structure of the inner profile component. For this purpose, for example, an additional profile can be provided which has the phase change accumulator, wherein the inner profile component can be seamlessly inserted into the additional profile with the phase change accumulator. This can facilitate a production of the inner profile component with phase change accumulator.

A further design form provides that the inner profile component further has a cable feed-through channel. In particular, hollow spaces in the vehicle body of a motor vehicle can already guide cables that can be laid through the cable feed-through channel. For example, in addition to cables, cable connectors or a bracing device, in particular a threaded rod or a rope, can be laid through the cable feed-through channel, for example in order to brace the cooling device in the hollow profile.

In a further design form, it is provided that the inner profile component is formed from plastic or metal. For example, the guide structure can also be formed from plastic or metal. Plastic results in the advantage that it can be generated quickly through 3D printing, which saves costs. The plastic can preferably be formed from a thermally conductive plastic so that a cooling performance can be further improved. The use of metal results in the advantage that it can receive additional heat.

A further design form provides that a fluid inlet for the heat carrier fluid is provided laterally to the transport channel or parallel to the transport channel. This means that, for example, it can be provided that the fluid inlet is provided transversely to the transport channel in order to introduce and/or discharge the heat carrier fluid. Alternatively, the fluid inlet can be provided at an end of the inner profile component so that the heat carrier fluid can be introduced in the direction of the transport channel.

The cooling device arrangement according to the invention can preferably be used for a motor vehicle, in particular for a passenger car or truck, or passenger bus or motorcycle.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a cooling device arrangement according to an exemplary embodiment;

FIG. 2 shows a cross section through a cooling device according to an exemplary embodiment;

FIG. 3 shows a cross section through a cooling device according to a further exemplary embodiment;

FIG. 4 shows a cross section through a cooling device according to a further exemplary embodiment;

FIG. 5 shows a cross section through a cooling device according to a further exemplary embodiment.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the already described features of the invention.

In the figures, same reference numerals respectively designate elements that have the same function.

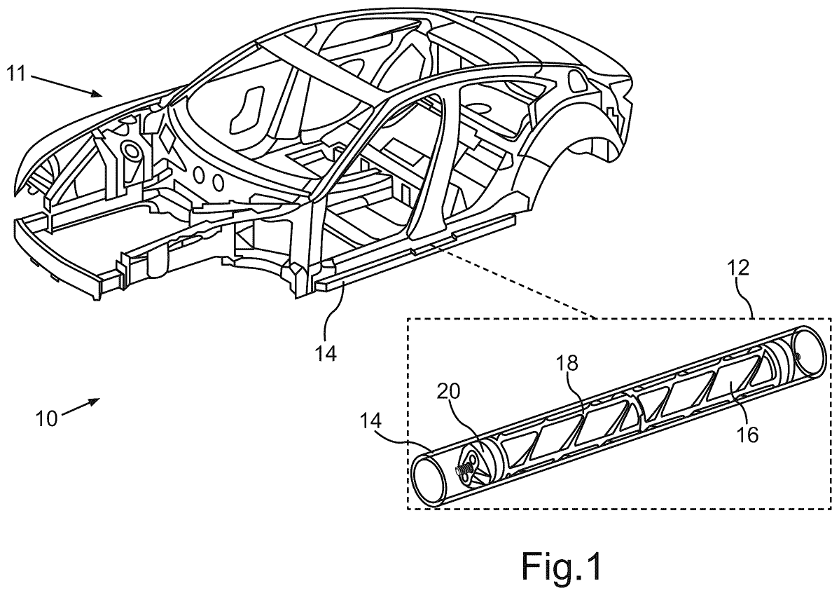

FIG. 1 represents a schematically represented cooling device arrangement 10 according to an exemplary embodiment. The cooling device arrangement 10 can be provided for a vehicle body 11 comprising vehicle body elements 14. In this example, a vehicle body element 14 can be, for example, a vehicle sill having a hollow profile that provides a receiving space for a cooling device 12. In addition to a vehicle sill, however, other vehicle body elements that provide a receiving space through a hollow profile can also be used for receiving the cooling device 12. In particular, a battery profile of a vehicle battery (not shown) can provide a suitable receiving space.

The cooling device 12 can be inserted into the receiving space of the hollow profile, which can be formed to cool vehicle components, in particular to receive temperature peaks. For this purpose, the cooling device 12 can have an inner profile component 16, which can be a profile through which a heat carrier fluid flows, which can receive and temporarily store heat. In particular, materials of the inner profile component 16 can be selected such that they can better receive the heat of the heat carrier fluid. The heat carrier fluid can be, for example, a gas, a liquid or a gas-liquid mixture that is guided from a vehicle component to the cooling device.

In the embodiment shown, a guide structure 18 can be arranged around the inner profile component 16, the dimensions of which are adapted to the hollow profile such that the cooling device 12 can be inserted into the receiving space of the hollow profile and can be held there at least on the sides in a form-fitting manner and without gluing. A transport channel for the heat carrier fluid can be formed by an intermediate space which is created between the inner profile component 16 and the vehicle body element 14, wherein the guide structure can have fluid guide ribs through which the heat carrier fluid is guided around the inner profile component 16 and thus flows around it.

Furthermore, end caps 20 or covers can be provided which seal the cooling device 12 towards the end sides, wherein the cooling device 12 can be braced in a position by means of the end caps 20, for example.

Several embodiments for structures of the cooling device 12 are described below, which can also be embodied as combinations. In particular, the following figures represent cross sections through a longitudinal direction of the cooling device 12, wherein the cooling device 12 is represented in tubular in these embodiments. It is noted that the cooling device 12 can have other shapes which can be in particular adapted to the hollow profile of the vehicle body element 14.

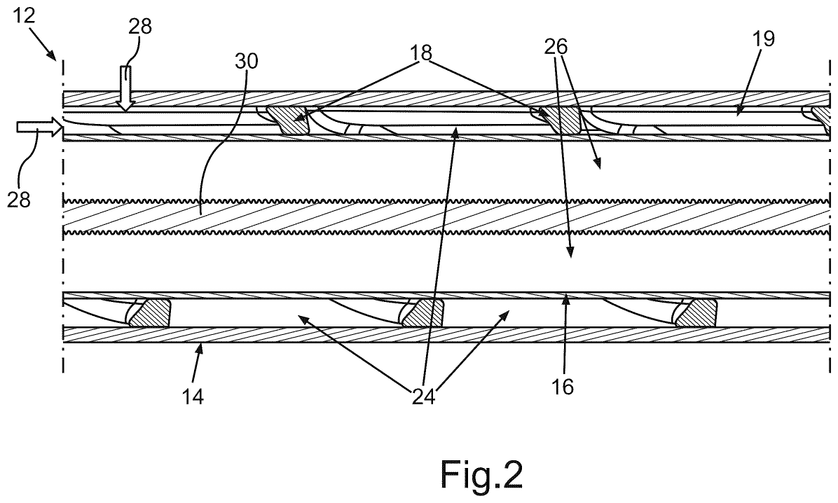

FIG. 2 represents a schematic cross section through a cooling device 12 according to an exemplary embodiment. Here, the inner profile component 16, which has a guide structure 18, is inserted into the hollow profile of the vehicle body element 14. The guide structure 18 can have fluid guide ribs which are arranged circumferentially around the inner profile component 16 and define a distance from the vehicle body element 14, so that an intermediate space is generated between the vehicle body element 14 and the inner profile component 16, through which a transport channel 24 for the heat carrier fluid is provided. In addition to the fluid guide ribs, the guide structure 18 can also have stiffening ribs 19 which increase a stability.

For introducing the heat carrier fluid, one or more fluid inlets 28 can be provided, which can be provided, for example, laterally or parallel to the transport channel 24.

The inner profile component 16 can have a phase change accumulator 26 for improved heat reception and heat storage, which is provided, for example, as an inner core of the inner profile component 16.

Furthermore, this figure represents a cable feed-through channel 30 which runs through a center of the inner profile component 16 and through which, for example, cables or cable plugs which can run through hollow profiles of the vehicle body 11 can be passed.

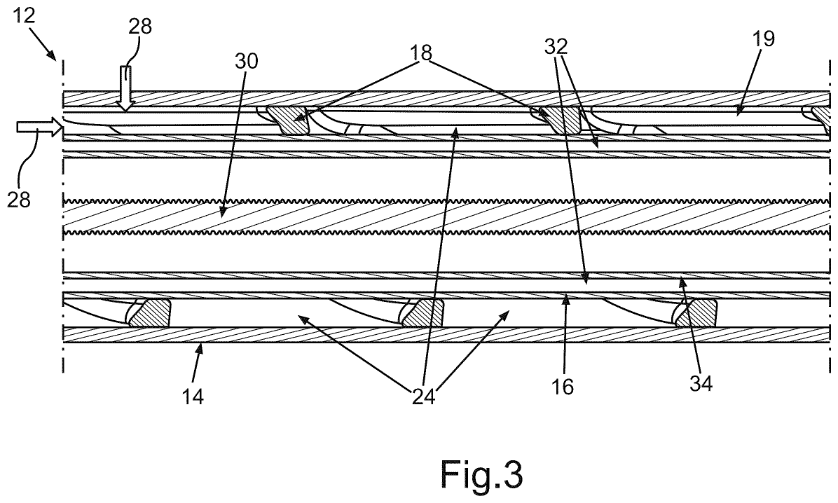

FIG. 3 represents a further schematic cross section through a cooling device 12 according to a further exemplary embodiment. In this embodiment, the inner profile component 16, which is enclosed by the guide structure 18, is pushed back into the hollow space of the vehicle body element 14 so that it is held there in a form-fitting manner and without gluing. The transport channel 24 can again be formed by the intermediate space that exists between the inner profile component 16 and the vehicle body element 14.

In this embodiment, in addition or alternatively to the phase change accumulator 26 (not shown in this figure) provided as an inner core of the inner profile component 16, a further or alternative phase change accumulator 32 can be provided which is arranged in an outer structure of the inner profile component 16. In this case, for example, an inner core 34 of the inner profile component 16 can be inserted into an additional profile which has the further or alternative phase change accumulator 32.

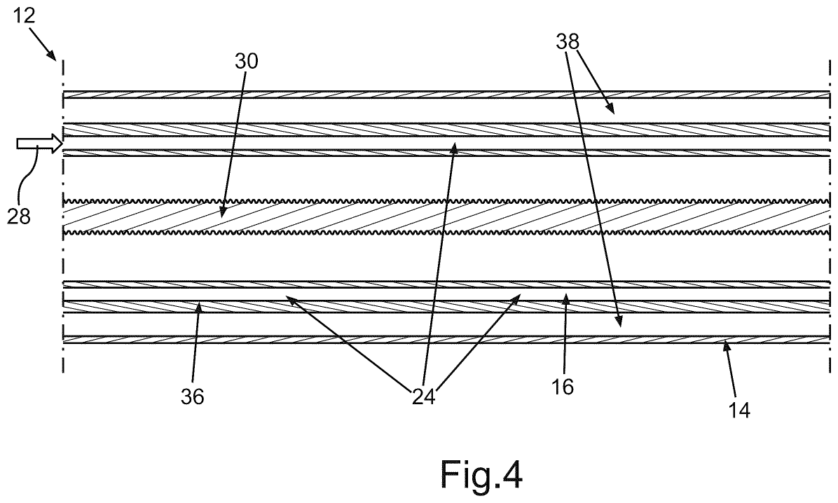

FIG. 4 represents a further cross section of a cooling device 12 according to a further exemplary embodiment. In this embodiment, the inner profile component 16 is inserted into an outer profile component 36, so that the transport channel 24 is formed by an intermediate space between the inner profile component 16 and the outer profile component 36. The outer profile component can be adapted to the hollow profile of the vehicle body element 14 such that the cooling device 12 can be seamlessly inserted into the receiving space of the hollow profile and is held there in a form-fitting manner and without gluing. The outer profile component can have an outer phase change accumulator 38, which is arranged between the vehicle body element 14 and the transport channel 24. This means that the phase change accumulator 38 is located externally here. The inner profile component 16 can, for example, also have the phase change accumulators 26, 32 described in the previous exemplary embodiments.

In the embodiment shown in FIG. 4, it can be provided, for example, that the cooling device 12 has no guide structure and the transport channel 24 is formed only by the intermediate space between the outer profile component 36 and the inner profile component 16.

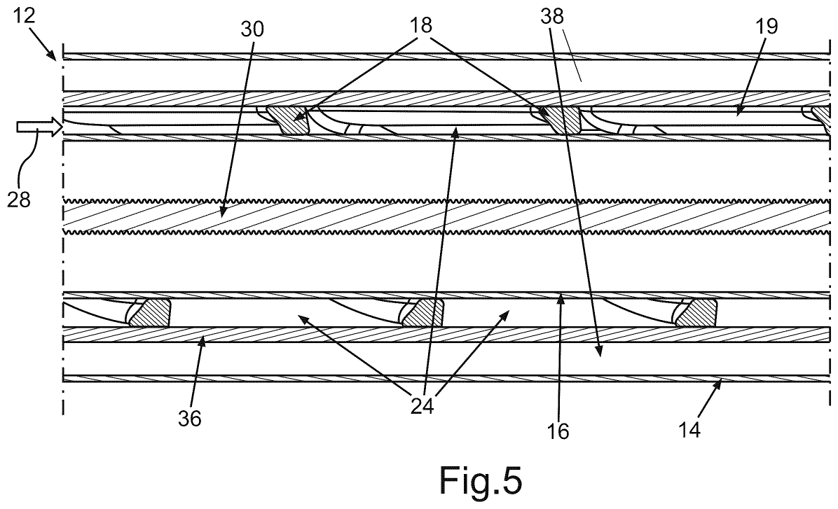

FIG. 5 represents a further cross section through a cooling device 12 according to a further exemplary embodiment. This embodiment can be based on the previously shown embodiment of FIG. 4, wherein additionally a guide structure 18 is inserted in the intermediate space between the outer profile component 36 and the inner profile component 16. Here too, the outer phase change accumulator 38 is arranged in the outer profile component 36 so that it is arranged between the vehicle body element 14 and the transport channel 24. As in the previous exemplary embodiment, an additional phase change accumulator 26, 32 of the inner profile component 16 can be provided or not.

Overall, the examples show how a displaceable, passive cooling system including heat storage can be provided.

1. A cooling device arrangement, comprising:
a vehicle body element with a hollow profile providing a receiving space;
a cooling device comprising an inner profile component on the outer surface of which a transport channel is provided through which a heat carrier fluid can flow;
wherein dimensions of the cooling device are adapted to the hollow profile such that the cooling device can be inserted into the receiving space of the hollow profile and is held in the receiving space in a form-fitting manner and without gluing.

2. The cooling device arrangement according to claim 1, wherein the cooling device further has a guide structure arranged on the outer surface of the inner profile component, wherein dimensions of the guide structure are adapted to the hollow profile such that the inner profile component with the guide structure can be inserted into the receiving space of the hollow profile and is held in the receiving space in a form-fitting manner and without gluing;
wherein, when the inner profile component with guide structure is inserted, an intermediate space is formed between the hollow profile and the inner profile component, which forms the transport channel for the heat carrier fluid.

3. The cooling device arrangement according to claim 1, wherein the cooling device further comprises an outer profile component into which the inner profile component can be inserted such that the outer profile component surrounds the outer surface of the inner profile component and the transport channel is formed in an intermediate space between the outer profile component and the inner profile component,
wherein the outer profile component has a phase change accumulator; and
wherein the outer profile component is adapted to the hollow profile such that it can be inserted into the receiving space of the hollow profile and is held in the receiving space in a form-fitting manner and without gluing.

4. The cooling device arrangement according to claim 3, wherein a guide structure for guiding the heat carrier fluid is arranged in the intermediate space which forms the transport channel.

5. The cooling device arrangement according to claim 1, wherein the inner profile component has a phase change accumulator which is formed and arranged to receive heat of the heat carrier fluid by changing a phase state.

6. The cooling device arrangement according to claim 5, wherein an inner core of the inner profile component is formed as a phase change accumulator.

7. The cooling device arrangement according to claim 5, wherein the phase change accumulator is arranged in an outer structure of the inner profile component.

8. The cooling device arrangement according to claim 1, wherein the inner profile component further has a cable feed-through channel.

9. The cooling device arrangement according to claim 1, wherein the inner profile component is formed from plastic or metal.

10. The cooling device arrangement according to claim 1, wherein a fluid inlet for the heat carrier fluid is provided laterally to the transport channel or parallel to the transport channel.

11. The cooling device arrangement according to claim 2, wherein the inner profile component has a phase change accumulator which is formed and arranged to receive heat of the heat carrier fluid by changing a phase state.

12. The cooling device arrangement according to claim 3, wherein the inner profile component has a phase change accumulator which is formed and arranged to receive heat of the heat carrier fluid by changing a phase state.

13. The cooling device arrangement according to claim 4, wherein the inner profile component has a phase change accumulator which is formed and arranged to receive heat of the heat carrier fluid by changing a phase state.

14. The cooling device arrangement according to claim 2, wherein the inner profile component further has a cable feed-through channel.

15. The cooling device arrangement according to claim 3, wherein the inner profile component further has a cable feed-through channel.

16. The cooling device arrangement according to claim 4, wherein the inner profile component further has a cable feed-through channel.

17. The cooling device arrangement according to claim 5, wherein the inner profile component further has a cable feed-through channel.

18. The cooling device arrangement according to claim 6, wherein the inner profile component further has a cable feed-through channel.

19. The cooling device arrangement according to claim 7, wherein the inner profile component further has a cable feed-through channel.

20. The cooling device arrangement according to claim 2, wherein the inner profile component is formed from plastic or metal.
